(19) United States
(12) Patent Application Publication
(10) Pub. No.: US 2024/0161180 A1
(43) Pub. Date: May 16, 2024

(54) CONNECTING SHORT TERM RENTAL WITH DISTRIBUTED INFRASTRUCTURES

(71) Applicants: Jason Terry Coates, St. James's, London (GB); Oliver Coates Gonzalez, St. James's, London (GB); Michael Lorenzo Cecchini, St. James's, London (GB)

(72) Inventors: Jason Terry Coates, St. James's, London (GB); Oliver Coates Gonzalez, St. James's, London (GB); Michael Lorenzo Cecchini, St. James's, London (GB)

(21) Appl. No.: 17/987,443

(22) Filed: Nov. 15, 2022

(51) Int. Cl. G06Q 30/06; G06Q 50/16

(52) U.S. Cl. CPC G06Q 30/0645; G06Q 50/163; G06Q 2220/12

(57) ABSTRACT

Methods and systems for connecting short term rental with distributed infrastructure are provided. According to one example, a server maintains access to a plurality of property data contracts on a decentralized blockchain ledger, each property data contract associated with a real property in a locale and a cancellation policy data contract. The server receives a booking data operation including a cryptocurrency transaction and a cryptocurrency address and verifies the booking data operation relative to the cancellation policy contract. Responsive to the verifying, the server approves the booking data operation, processes the cryptocurrency transaction, and updates the decentralized blockchain ledger. After the booking data operation has been approved, the server runs a token data operation to provide a token to the cryptocurrency address associated with the user electronic device.

### FIELD OF THE INVENTION

The field of the invention is algorithmic digital currencies and distributed computing, and in particular, a platform and infrastructure for decentralized and distributed ownership, storage, sharing and consumption of digital tokens.

### BACKGROUND

The following description includes information that may be useful in understanding the present invention. It is not an admission that any of the information provided herein is prior art or relevant to the presently claimed invention, or that any publication specifically or implicitly referenced is prior art.

Short term rental (“STR”), also known as short stay rental or homestay, is an increasingly popular form of hospitality and lodging whereby guests take accommodation in entire homes (both apartments and houses) that are fully serviced for nightly stays. Short term rental guests benefit from increased space, privacy and functionality with greater private amenities (for families and groups especially) when compared with hotel stays.

However, existing platforms for short term rentals tend to act as an intermediary between landlords and guests and there tends to be a lack of data transparency apart from the centralized platform.

Not only that, hospitality guests in general do not have a direct voice in the governance of a property they may visit frequently.

Furthermore, existing platforms typically fail to address the need for payments for STR experiences in digital currencies or tokens.

Digital currencies or tokens provide one means for providing governance mechanics and compatibility. However, it is a challenging problem to implement a decentralized system for STR experiences, which addresses some of these challenges, including compatibility with traditional and distributed digital financial infrastructures and token governance.

There have been prior approaches in the area of distributed ledger technology in real estate applications. For example, the project known as CitaDAO and available at www.citadao.io provides a means to represent property on a blockchain network but only as an intermediary layer for ownership transfer, fractionalization and speculative evaluation. After the property is tokenized, its management is outsourced, placing it out of decentralized control.

There have been prior approaches in the area of distributed ledger technology in loyalty points applications. For example, the project known as LooksRare and available at www.looksrare.org provides a means to distribute loyalty rewards, but only for certain transactions performed on a blockchain network.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of features used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

There is still a need for a system of algorithmic digital currencies and distributed computing and a platform for connecting short term rental with distributed infrastructures.

### BRIEF DESCRIPTION OF THE DRAWINGS

Various objects, features, aspects, and advantages of the inventive subject matter will become more apparent from the following detailed description of preferred embodiments, along with the accompanying drawing figures in which like numerals represent like components.

FIG. 1 is a block diagram of a system architecture for connecting STR with distributed infrastructure in accordance with an example of the present specification;

FIG. 2 is a sequence diagram of a method for connecting STR with distributed infrastructure, in accordance with an example of the present specification;

FIG. 3 is a block diagram of a verification engine according to the system architecture of FIG. 1 and in accordance with an example;

FIG. 4 is a block diagram of a booking engine according to the system architecture of FIG. 1 and in accordance with an example;

FIG. 5 is a schematic diagram of a server according to the system architecture of FIG. 1 and in accordance with an example;

FIG. 6 is a flowchart of a method for connecting STR with distributed infrastructure, according to an example of the present specification;

FIG. 7 is a block diagram of a system architecture including a server in communication with external services in accordance with an example of the present specification;

FIG. 8 is a block diagram of a system architecture including a server enabling direct digital currency payments across multiple distributed networks in accordance with an example of the present specification;

FIG. 9. is a flowchart of a method for completing an STR booking in accordance with an example of the present specification;

FIG. 10. is a flowchart of a method for assigning tokenback rewards in accordance with an example of the present specification;

FIG. 11. is a flowchart of a method for distributing tokenback rewards in accordance with an example of the present specification;

FIG. 12. is a flowchart of a method for onboarding a user of external partner platforms in accordance with an example of the present specification;

FIG. 13. is a flowchart of a method for distributing tokenback rewards to an external partner platform user in accordance with an example of the present specification; and

FIG. 14 is a block diagram of an architecture for a digital token network in accordance with an example of the present specification.

### DETAILED DESCRIPTION

Throughout the following discussion, references may be made regarding computing devices, servers, services, interfaces, engines, modules, clients, peers, portals, platforms, or other systems formed from servers. It should be appreciated that the use of such terms is deemed to represent one or more servers having at least one processor (e.g., ASIC, FPGA, DSP, x86, ARM, ColdFire, GPU, multi-core processors, system-on-a-chip, etc.) configured to execute software instructions stored on a computer readable tangible, non-transitory medium (e.g., hard drive, solid state drive, RAM, flash, ROM, etc.). For example, a computing device or server can include one or more computers operating as a web server, database server, or other type of computer server in a manner to fulfill described roles, responsibilities, or functions. One should further appreciate the disclosed algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial or health data query protocols, or other electronic information exchanging methods. Data exchanges can be conducted over a packet-switched network, the Internet, LAN, WAN, VPN, or other type of packet switched network.

One should appreciate that the systems and methods of the inventive subject matter provide various technical effects, including the facilitation of a convenient and efficient platform for STR inventory and loyalty rewards, improving utilization of housing stock especially in urban locales in which there is housing pressure as well as climate impacts. For example, STR can promote more efficient use of existing housing stock both by increasing utilization and eco-efficiency.

A system for connecting STR with distributed infrastructure includes a network of connected servers and electronic user devices. The user devices can be associated with STR guests and/or providers. Each computing and/or user device generally comprises a processor, a network interface device, and a data storage system. The network interface device of a server and user device is connected over a network to other servers and user devices. According to one example, the system is implemented using a decentralized architecture in which the servers function as blockchain nodes.

The specification is directed to a platform for distribution of token rewards to STR guests. In one example, the platform works in an ecosystem of STR providers, STR guests and others within the ecosystem. The term provider refers to an entity or application that is associated with a real property in a given locale, typically a master lease for an apartment or house in a city such as London, New York or Singapore. The term guest refers to an entity or application that is associated with a customer that wants to book a stay with a provider.

According to examples of the present specification, methods and systems for distributing STR tokens are provided. According to one example, a server, including a processor, a memory, and a network interface device connected to a network, maintains access to a plurality of property data contracts on a decentralized blockchain ledger, each property data contract associated with a real property in a locale and a cancellation policy data contract. The server receives a booking data operation from a user electronic device comprising a cryptocurrency transaction and a cryptocurrency address, verifies at least one attribute of the user electronic device relative to the cancellation policy contract, and responsive to the verifying, approves the booking data operation based on at least one attribute of the user electronic device, processes the cryptocurrency transaction and updates the ledger. After the booking data operation has been approved, running a token data operation to provide a token to the cryptocurrency address associated with the user electronic device.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, a blockchain ledger refers to a distributed record of transactions. A blockchain is a distributed network of peer-to-peer electronic devices that process and record transactions as part of a chain of blocks (blocks referring to electronic records or transactions). Once a block is completed, the block is added to the blockchain and the ledger is thereby updated. In many instances, a blockchain ledger of transactions or data is organized in chronological order or alternatively the data may be presented in any other order that is suitable for use by the blockchain network. In some configurations, transactions recorded in the blockchain may include a destination address and a currency or other fields, such that the blockchain records how much currency is attributable to a specific address. In many instances, additional information is captured, such as a time-stamp, source address, and the like. A blockchain implements a distributed ledger, that is a distributed database, jointly operated by the parties or participants of the ecosystem or network. Transactions on the ledger are committed by electronic consensus, speeding up the technical operations of participants.

Furthermore, as used herein, a smart data contract is a data operation performed on a ledger. In this specification, derived data refers to data produced as a result of a smart data contract (also referred to as an electronic contract or smart contract) or a data operation. According to examples of the present specification, booking data operations can be run as electronic contracts that execute a sequence of data operations after receiving approval from the property data smart data contract, also called a booking manager smart data contract. According to one example, after a user is granted approval and while the user's approval is not expired, the user can run operations without seeking subsequent approval.

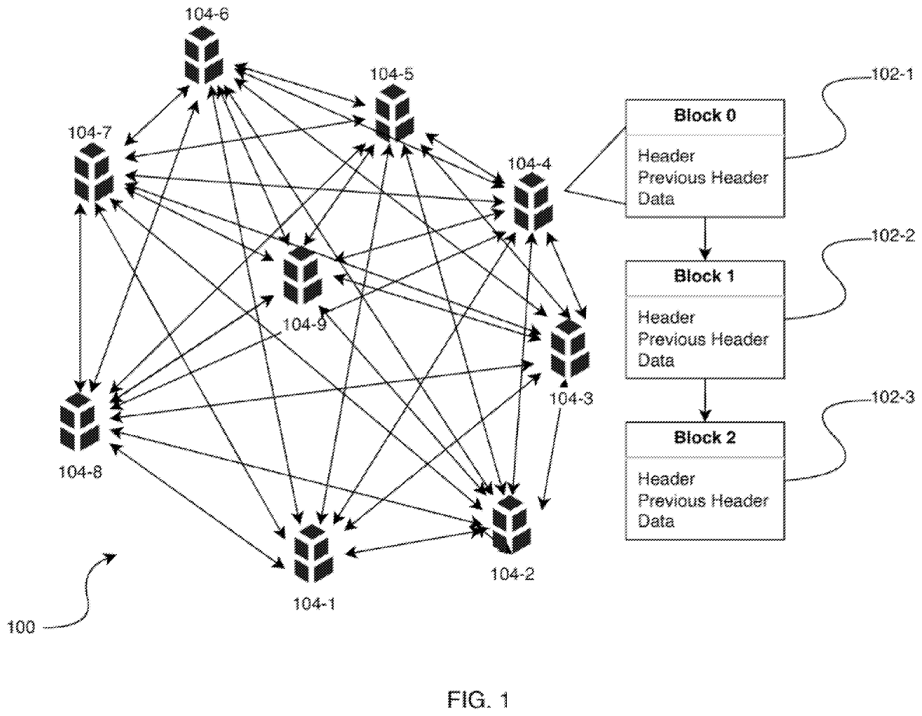

FIG. 1 illustrates the architecture of a decentralized system 100 that incorporates a distributed ledger (shown as blockchain nodes 104) and shares data (shown as blocks 102) among many participants by using a distributed database across many nodes 104. FIG. 1 illustrates multiple nodes given by reference numbers 104-1, 104-2, 104-3, 104-4, 104-5, 104-6, . . . 104-n. As suggested, the system 100 includes one or more nodes 104 connected by links that communicatively couple the nodes via one or more data exchange networks (e.g., Internet, cellular, Ethernet, LAN, WAN, VPN, wired, wireless, short-range, long-range, etc.).

The decentralized system 100 is a network of servers that maintains a distributed ledger of digital tokens or loyalty points. The ledger is a consensus of replicated, shared, and synchronized digital data geographically spread across multiple providers, countries, and sites. In this case, the data can be tokens on the Ethereum or other Ethereum Virtual Machine (EVM) compatible blockchain. Tokens can be associated with a vote in the governance of a property.

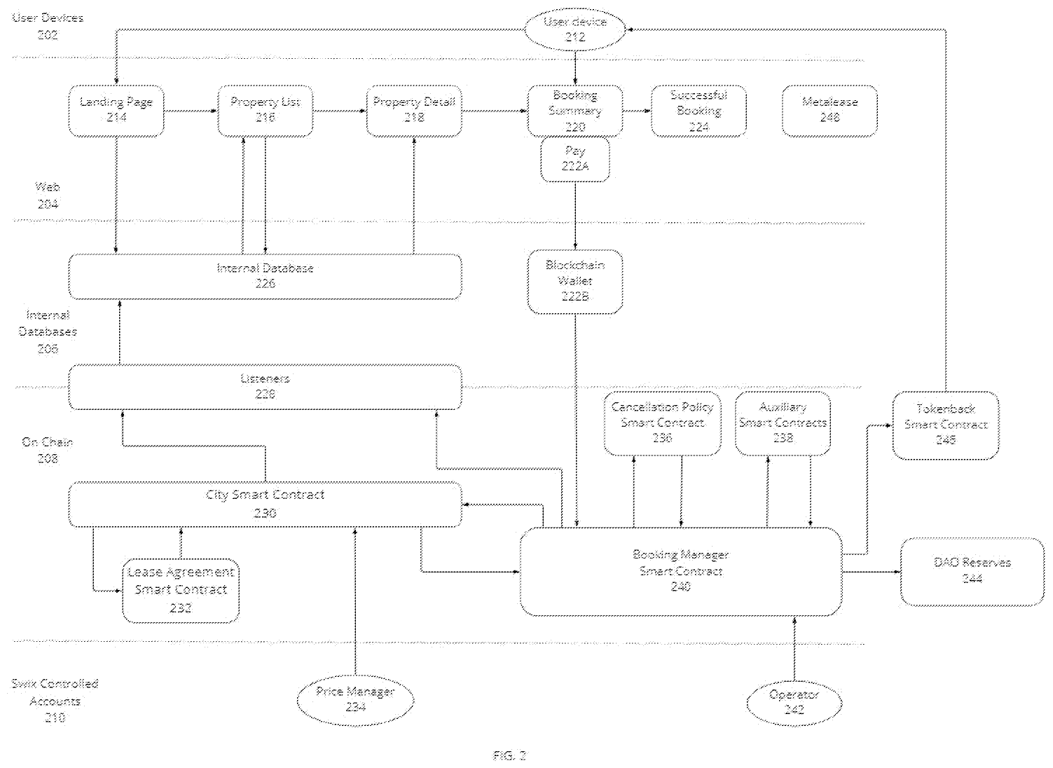

FIG. 2 shows the features of the hospitality platform 200 according to one example: user devices 202 (also called user electronic devices), web pages or applications making up the booking platform 204 (also referred to as the “Swix” ™ marketplace), databases 206, blockchain smart data contracts 208, and account addresses 210. In operation, the user devices 202 can browse elements of the booking platform 204 such as by launching page 214, which allows searching for available STR based on input parameters. As shown in FIG. 2, the booking platform 204 functions to render a display a plurality of STR listings from the internal database 226 that are available for booking from landing page 214. User devices 202 can accept user queries including a location and dates and receive a property list at page 216, with additional details available for a selected property available at page 218. To proceed with a booking, the booking page or application 220 generates a booking data operation 222A against a blockchain wallet 222B of a user device 202. In one example, blockchain wallet 222B is a virtual wallet that manages an Ethereum or distributed network compatible account address. The smart data contract 222A interacts with the booking manager smart data contract 240 as explained below. As shown in FIG. 2, web application 224 can monitor data operations on various of the blockchain smart data contracts 208. In one example, the booking platform 204 can be implemented as a decentralized web3 application also known as a “dapp”.

Still with reference to FIG. 2, the internal database 226 is in networked communication with listeners 228 that monitor all smart data contracts 208 which state changes result in relevant updates performed in the internal database 226, such as updating the availability of STR listings or other digital assets, bookings status and smart data contracts 208 addresses. One or more lease agreement smart data contracts 232 can be deployed and attached to a city smart data contract 230, minting to the city smart data contract 230 tokens representing each individual night of the underlying lease. Code executed in a city smart data contract 230 triggered by price manager's wallet 234 establishes the prices and exposes nights as available. Booking manager smart data contract 240 stores and executes the booking logic based on data provided by the blockchain wallet 222B. Parts of logic used to compute booking parameters are stored in other smart data contracts, 236 and 238. The cancellation policy smart data contract 236 receives booking parameters and returns to the booking manager smart data contract 240 booking cancellation refunds deadlines. Auxiliary smart data contracts 238 process relevant booking parameters, such as price or booked nights, enabling implementation of additional logic such as applying discounts.

A lease agreement smart data contract 232 is associated with a real property of a provider, be it under a master lease, sublease, intervening lease, or a freehold. The lease agreement smart data contract 232 can represent any STR asset held by a participant in a hospitality ecosystem including hotel groups, STR platforms, time share providers, realtors, property funds, etc.

According to one example, the depositary reserve smart data contract 244 includes code to regulate supply/demand of tokens. Tokens can be staked. This allows a token holder to “invest” their tokens and earn passive income. Alternatively, tokens can be pledged as a security deposit for a stay, redeemed for cash or other rewards or swapped for other digital tokens on a decentralized exchange. The tokens can be spent for stays, experiences and merchandise. All these items can be added to the properties database 226 or another database that is exposed to the booking platform 204.

Still with reference to FIG. 2, metalease 224 provides logic to generate business intelligence information to reveal trends or forecasts such as what types of properties, amenities, etc. guests are seeking from providers and represent the value of each lease in the form of financial metrics, availability calendar, legal documents and 3d digital representation of the property.

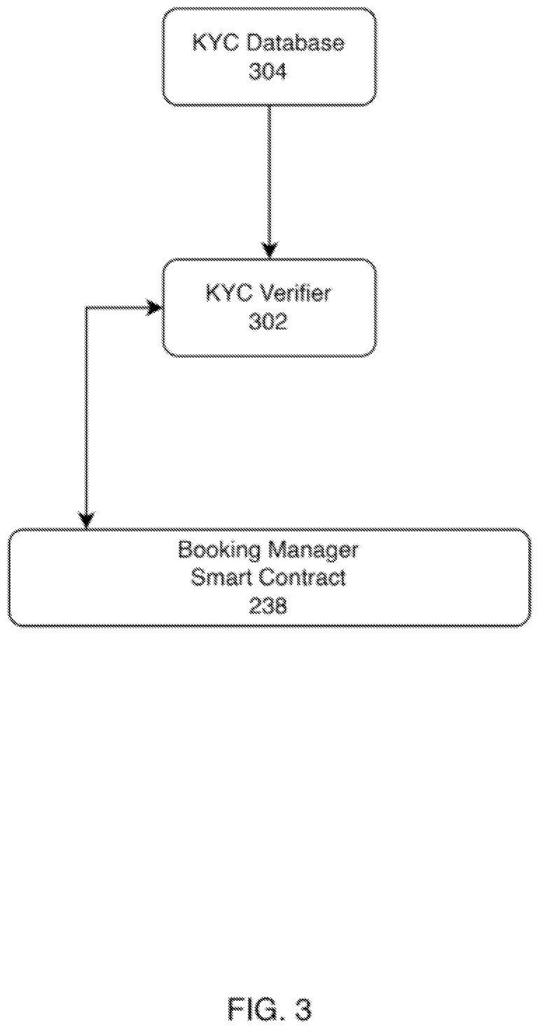

Now with reference to FIG. 3, KYC or know-your-client verification is a process external to the booking platform 204, according to this example. A guest's KYC data, also referred to as an attribute, can be mapped to a unique hash and stored in database 304. Once mapped the hashes can be added to a KYC Verifier smart data contract 302 and used to confirm the KYC requirement for bookings by guests via the booking manager smart data contract 240.

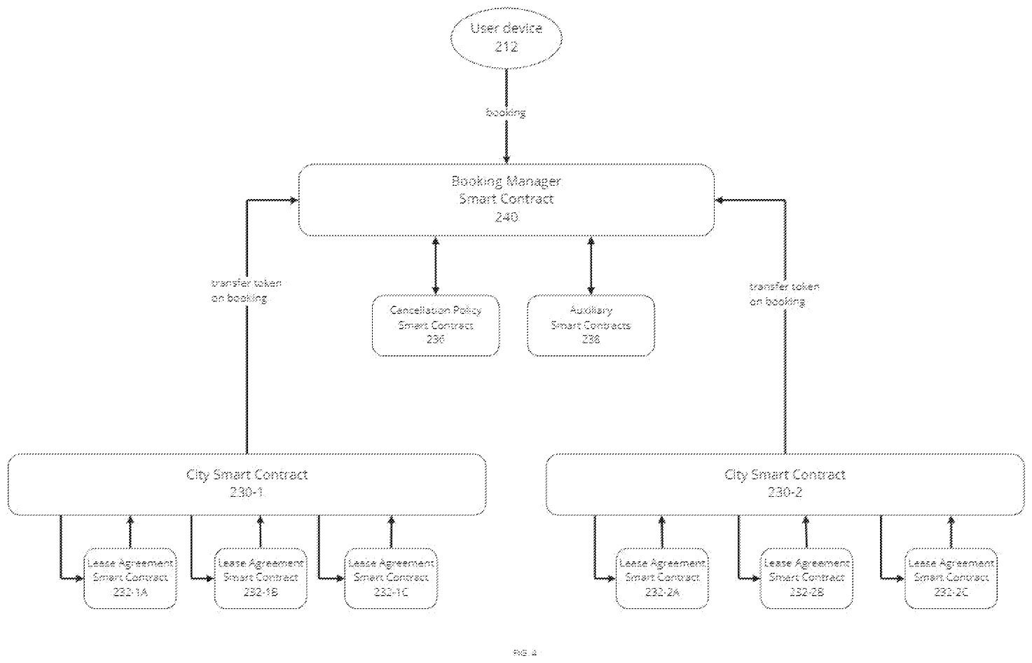

Turning to FIG. 4, according to one example, each property available on the booking platform 204 can be mapped “on-chain” meaning attached as a lease agreement smart data contract 232. Each city or locale in which the system operates can be represented on-chain as a city smart data contract 230. Every lease agreement smart data contract 232 can be added to one city smart data contract 230 at a time and once claimed will mint to the corresponding city smart data contract 230 token, such as ERC1155 tokens, representing each individual night throughout the whole duration of the lease period. ERC1155 tokens are a type of token on the Ethereum or other EVM compatible blockchain but the scope of the present specification is not limited to this type of token.

According to one example, the city smart data contract 230 is the smart data contract through which each night is assigned a price and made available to book. The booking manager smart data contract 240 is a common smart data contract for all city smart data contracts 230 and contains the booking logic. On booking, the booking manager smart data contract 240 pulls corresponding ERC1155 night tokens from the city smart data contract 232 and stores booking data, verifying the cancellation policy through the cancellation policy smart data contract 236 and derives the final price and other booking parameters through auxiliary smart data contracts.

User devices 202 can cancel a booking and may receive a refund depending on chosen cancellation policy. They can also claim tokenback, which will result in withdrawing their cancellation rights, if they have any. On taking any of those actions the funds not sent back to the user device 202 will be transferred to an address associated with token reserver (DAO reserves) 244.

As noted above, according to one example, KYC verification can be performed through the booking manager smart data contract 240 using the KYC Verifier smart data contract 302 (not shown in FIG. 4).

To facilitate keeping track of all smart data contract addresses and roles throughout the whole network, smart data contracts can be connected through an ecosystem smart data contract (not shown in FIG. 4) which stores the addresses of all smart contracts and roles, which are explained in greater detail below. After deployment, smart data contracts which require additional data about other smart data contracts may query the ecosystem smart data contract using the methods relevant to the required address (not shown in FIG. 4). The lease agreement smart data contract 232 is activated by a city smart data contract 230 once it is added to one. According to one example, they are deactivated if detached from the city smart data contract 230.

The ecosystem smart data contract can keep track of on-chain “roles” which, according to one example, include 1) Token Governance: this is the most powerful role and represents the voice of the community of token holders; 2) Lease Manager: this role is responsible for deploying new lease agreement smart data contracts 232 and attaching them to a corresponding city smart data contract 230; 3) Lease Policy Counsel: this role is responsible for setting and adjusting rates; 4) Cost Manager: this role is responsible for adding global and city costs; 5) Cancellation Policy Manager: this role is responsible for adding and removing cancellation policy smart data contracts 236; 6) Contract Manager: this role is responsible for adding and removing smart contracts from the ecosystem smart data contract; 7) Price Manager: this role is set on a per city basis, and is responsible for pricing and changing availability of nights in each city smart data contract 230; and DAO Reserves: this role is a wallet or address that receives all profit going to DAO or decentralized autonomous organization.

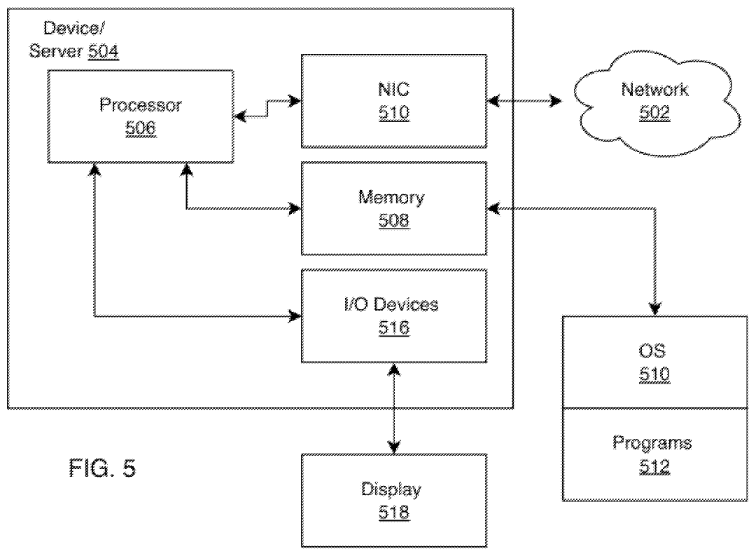

Turning to FIG. 5, server 504 can include one or more computing devices programmed to perform booking and token data operations. Thus, the server 504 can include at least one processor 506, at least one non-transitory computer-readable storage medium shown as memory 508 (e.g., RAM, ROM, flash drive, solid-state memory, hard drives, optical media, etc.) storing computer readable instructions that cause the processors to execute functions and processes of the inventive subject matter, and communication interfaces, such as network interface devices, that enable the server 504 to perform data exchanges with other servers 504 and to create a network of peer-to-peer servers 504. The computer-readable instructions (shown as OS 510 and Programs 512) that the server 504 uses to carry out its functions can be instructions allowing the server 504 to access, retrieve, and process data operations to authorized parties, access control functions, data sharing, merging, etc. The server 504 can include input/output interfaces 516 (e.g., keyboard, mouse, touchscreen, display 518, sound output devices, microphones, sensors, etc.) that allow an administrator or other authorized user to enter information into and receive output from the server 504. Examples of suitable computing devices for use as a server 504 can include cloud services, server computers, desktop computers, laptop computers, tablets, smartphones, smartwatches, wearables, IoT devices, etc.

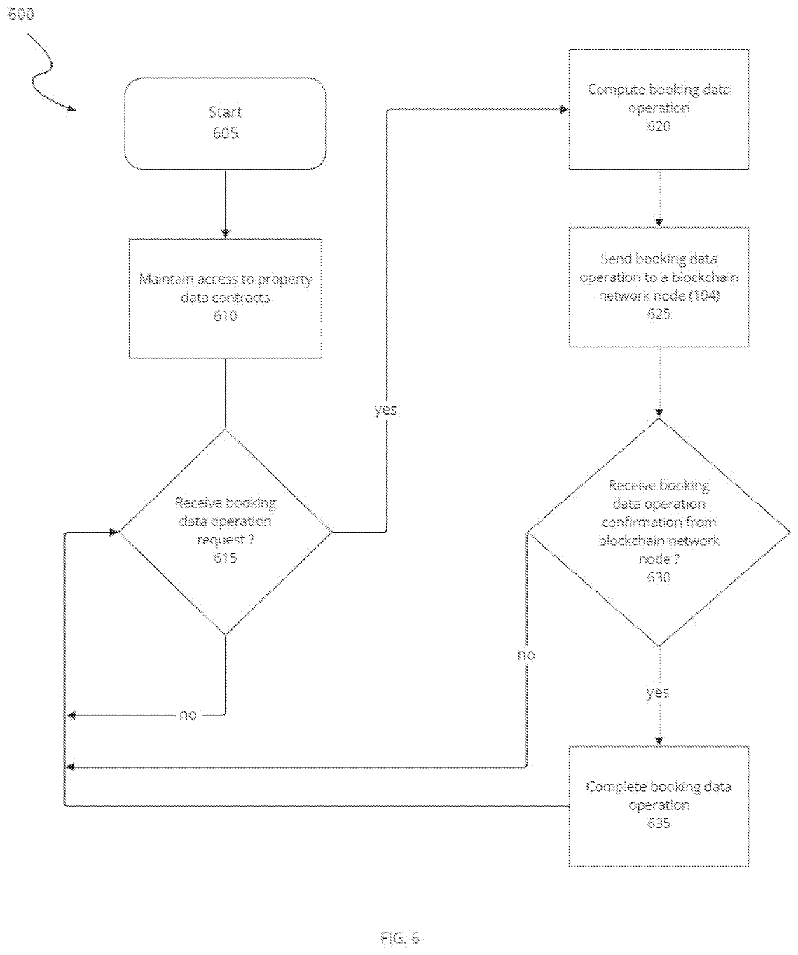

A flowchart illustrating an example of a method of connecting STR with distributed infrastructure is shown in FIG. 6. This operation or method can be carried out by applications or software executed by, for example, a processor of the server 504. The method can contain additional or fewer processes than shown and/or described and can be performed in a different order. Computer-readable code executable by at least one of the processors to perform the method can be stored in a computer-readable storage medium, such as a non-transitory computer-readable medium.

With reference to FIG. 6, a method 600 starts at 605 and, at 610, a server 504 maintains access to an internal database 226. At 615, the server 504 receives a booking data operation request from the user. At 620, the server 504 computes the booking data operation based on the user's request using a blockchain wallet 222B. In 625 the server 504 sends booking data operation to a blockchain network node 104, which verifies booking data operation relative to the cancellation policy smart contract 236 via booking manager smart contract 240. At 630, the server 504 receives confirmation of the booking data operation verification from a blockchain node 104. At 635, the booking data operation is completed, and the method returns to monitor for booking data operations requests at 615.

The following paragraphs describe in more detail intermediary states of the system.

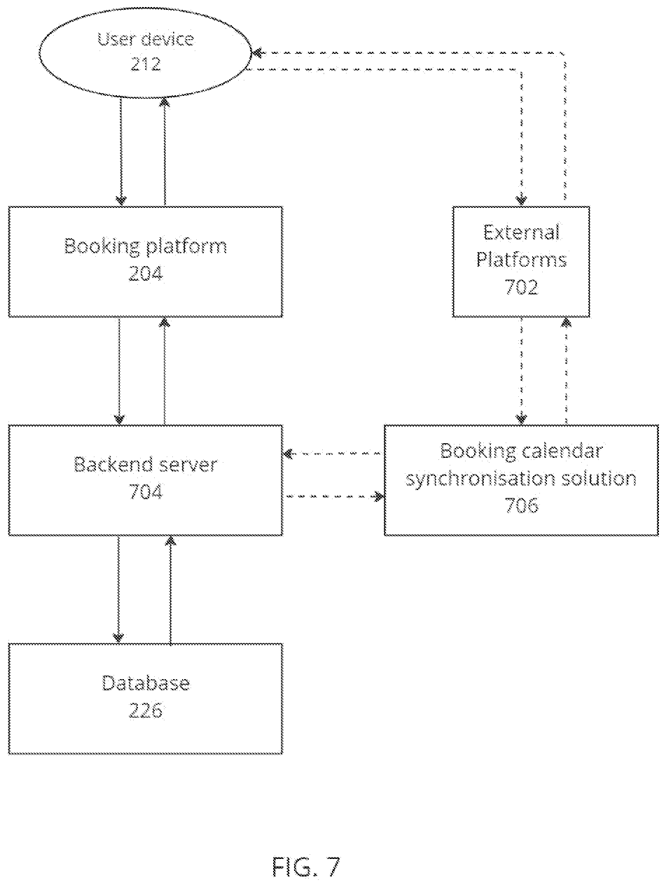

FIG. 7 shows a system exposed to external services. Availability can be stored in a database 226 and displayed on user device 212 through the booking platform 204. User devices 202 can also access the availability of the STR through external partner platforms 702. All bookings coming from both the booking platform 204 and the external partner platforms 702 are processed by server 504 and updated in the database 226. Moreover, an availability synchronisation solution 706 external to the server 504 functioning as a backend server 704 may be used in order to ensure the consistency of the data across all platforms.

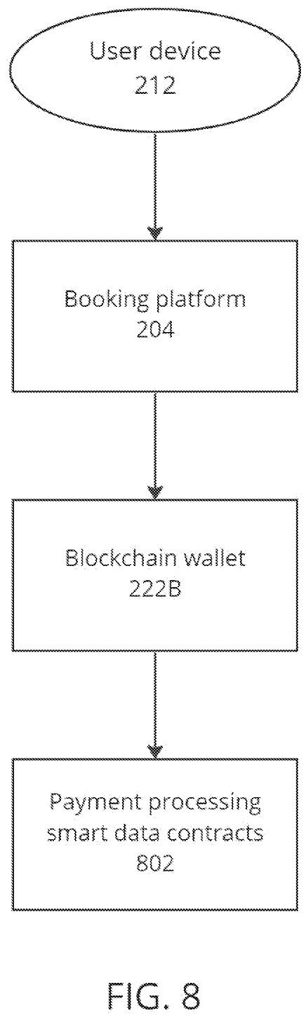

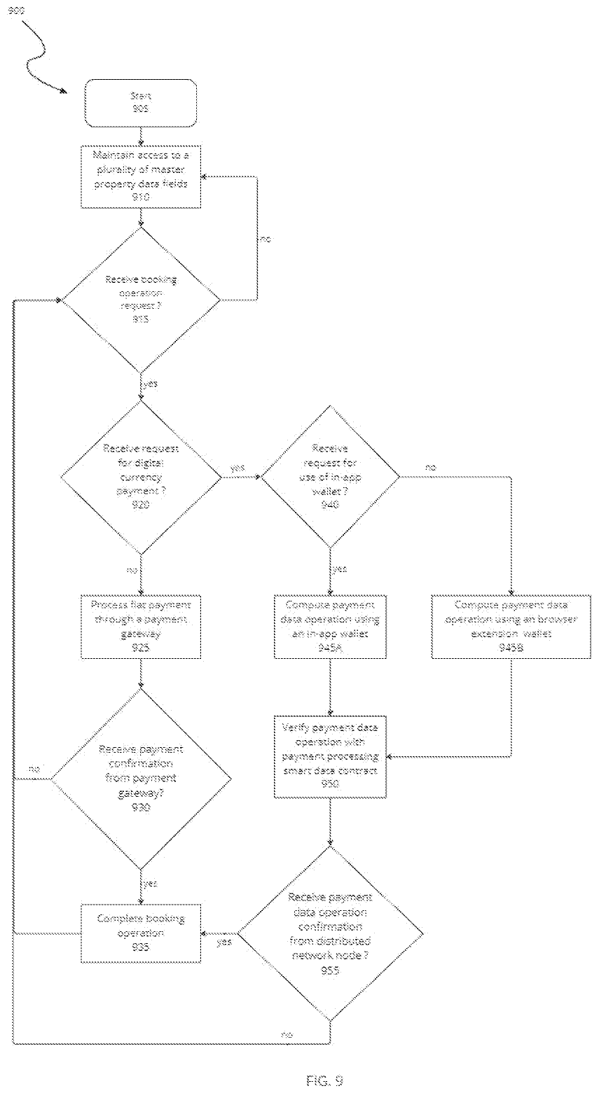

FIG. 8. shows a system architecture enabling digital currency payments 222A on the booking platform 204 across multiple distributed networks. User device 202 using a blockchain wallet 222B connects to a supported distributed network. The support is defined by a payment processing smart data contract 802 being deployed and maintained on the distributed network. The process of transaction settlement is consistent with the process shown on FIG. 9.

The following operations or methods can be carried out by applications or software executed by, for example, a processor of the server 504. The methods can contain additional or fewer processes than shown and/or described and can be performed in a different order. Computer-readable code executable by at least one of the processors to perform the method can be stored in a computer-readable storage medium, such as a non-transitory computer-readable medium.

A flowchart illustrating an example of a method of connecting STR with distributed infrastructure using booking platform 204 is shown in FIG. 9.

With reference to FIG. 9, a method 900 starts at 905 and, at 910, a server 504 maintains access to an internal database 226. At 915, the server 504 receives a booking operation request from the user device 212. At 920, the server 504 receives a request form the user device 212 for a digital currency payment. In this case at 940 the server 504 receives a further request from the user device 212 to use the in-app wallet to process the payment and computes the booking data operation based on the user's request 945A. Alternatively, at 940, the server 504 receives a request to use an external blockchain wallet 222B to process the payment in which case the payment data operation is computed 945B through an external blockchain wallet 222B. At 950, the server 504 verifies the payment data operation against the payment processing smart data contract 804 and, at 955 receives the payment data confirmation from a blockchain node 104, thus completing the booking operation 935.

Still with reference to FIG. 9 at 920 the server 504 may receive a request for a fiat payment, in which case at 925 the payment operation is processed via an external payment gateway. At 930 the server 504 receives the confirmation of the payment operation from the payment gateway system, thus completing the booking operation.

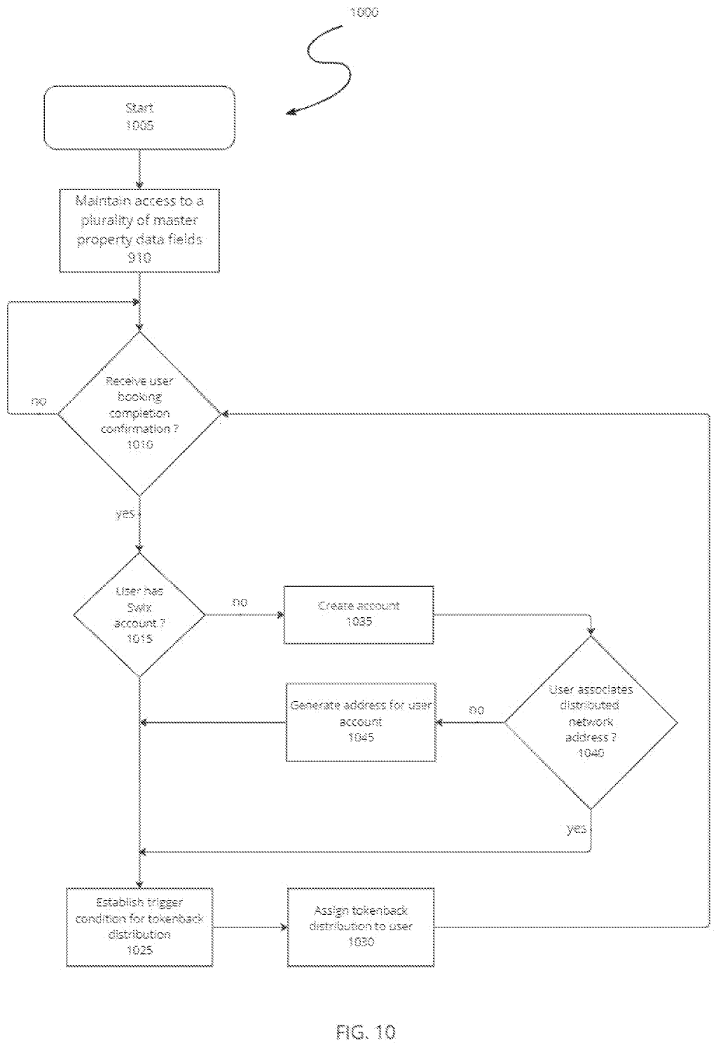

A flowchart illustrating an example of a method of assigning tokenback to a user of the booking platform 204 is shown in FIG. 10. A method 1000 starts at 1005 and, at 910, a server 504 maintains access to an internal database 226. At 1010 the server 504 receives the confirmation of booking completion from the user device 212. At 1015 the server 504 confirms that the user device 212 is associated with an account registered in the database 226 and at 1025 the server 504 determines the trigger condition for tokenback distribution operation. At 1030 the server 504 assigns the tokenback amount to the cryptocurrency address associated with the user's account.

Still in reference to FIG. 10. at 1015 the server 504 may verify that the user device 212 is not associated with an account registered in the database 226. At 1035 the server 504 registers a new user's account and at 1040 the server 504 receives a request to associate an existing cryptocurrency address with the newly created user account. Alternatively at 1045 the server 504 generates a new cryptocurrency address, which is associated with a newly registered account, created at 1035.

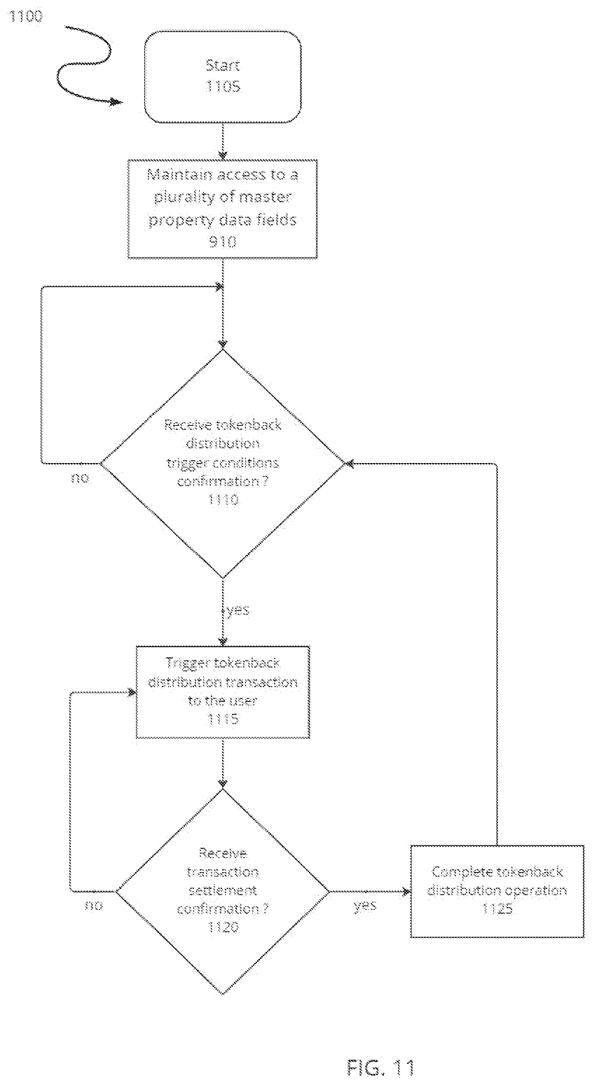

A flowchart illustrating an example of a method of distributing tokenback to a user of the booking platform 204 is shown in FIG. 11. A method 1100 starts at 1105 and, at 910, a server 504 maintains access to an internal database 226. At 1110 the server 504 receives confirmation that the trigger conditions for tokenback distribution have been met and at 1115 the server 504 triggers tokenback distribution to the user's cryptocurrency address. At 1120 the server 504 receives the tokenback distribution transaction settlement confirmation from a blockchain node 104, thus completing the tokenback distribution operation at 1125.

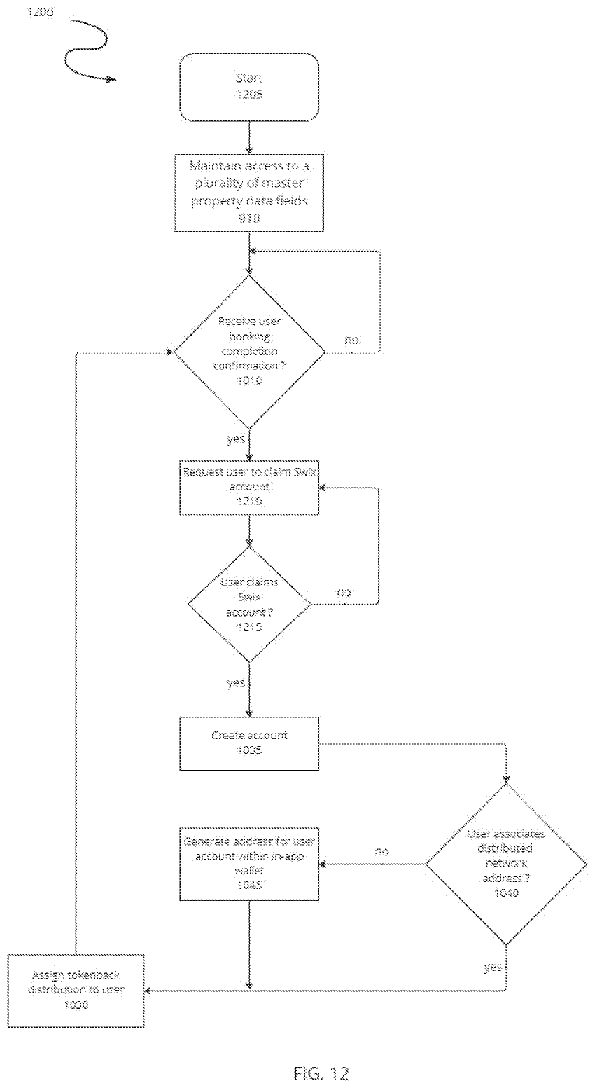

A flowchart illustrating an example of a method of onboarding a user of external partner platforms 702 is shown in FIG. 12. A method 1200 starts at 1205 and, at 910, a server 504 maintains access to an internal database 226. At 1010 the server 504 receives the confirmation of booking completion from the external platform 702. At 1210 the server 504 sends a request to the user device 212 to claim a user account. At 1215 the server 504 receives confirmation from user device 212 that the user has claimed the account and at 1135 the server 504 registers an account associated with the user device 212 in the database 226. At 1040 the server 504 receives a request to associate an existing cryptocurrency address with the newly created user account. Alternatively at 1045 the server 504 generates a new cryptocurrency address, which is associated with a newly registered account, created at 1035. At 1030 the server 504 assigns the tokenback amount to the cryptocurrency address associated with the user's account.

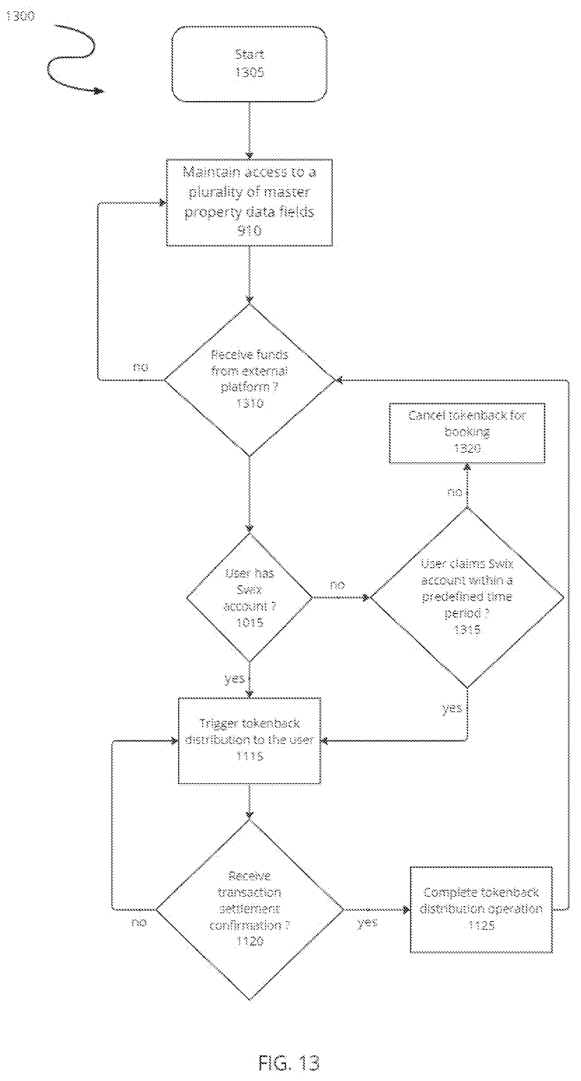

A flowchart illustrating an example of a method of distributing tokenback to a user of the external partner platforms 704 is shown in FIG. 13. A method 1300 starts at 1305 and, at 910, a server 504 maintains access to an internal database 226. At 1310 the server 504 receives confirmation of the funds transfer from the external platform 704. At 1015 the server 504 verifies that the user device 212 is associated with an account registered in the database 226 and at 1115 the server 504 triggers tokenback distribution to the user's cryptocurrency address. At 1120 the server 504 receives the tokenback distribution transaction settlement confirmation from a blockchain node 104, thus completing the tokenback distribution operation at 1125.

Still in reference with FIG. 13, at 1015 the server 504 may verify that the user device 212 is not associated with any account registered in the database 226. In this case at 1315 the server 504 verifies that the user claims the account according to the method 1200 shown in FIG. 12. and at 1115 the server 504 triggers the tokenback distribution to the user's cryptocurrency address. Alternatively, if at 1315 the server 504 verifies that the user of the external partner platform 704 has failed to claim the account within a predefined time period, at 1320 the server 504 cancels the pending tokenback associated with the booking in question.

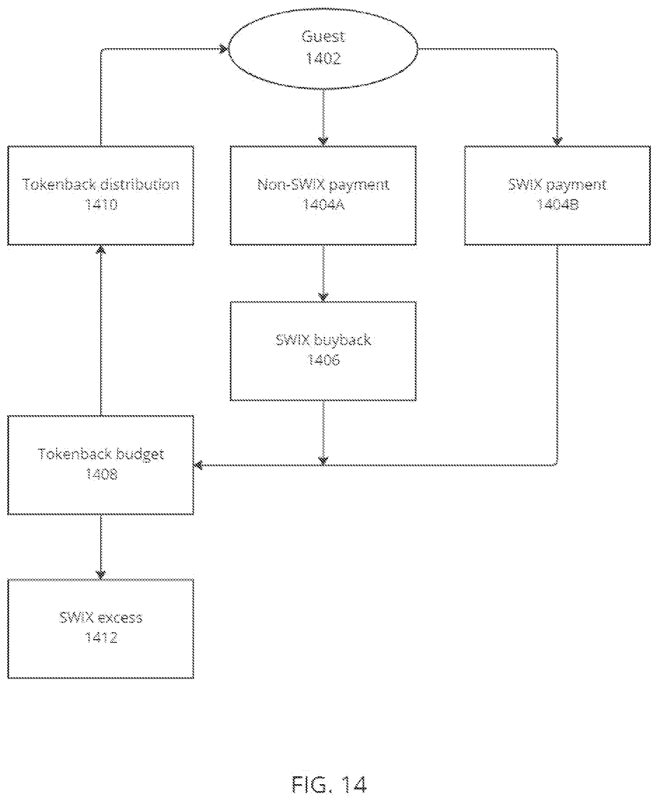

FIG. 14 shows a system architecture for a digital token network serving as a value bridge between the STR and distributed infrastructure. User devices 202 associated with STR guests 1402 can pay for their stays in two ways: 1) using SWIX digital token 1404B or 2) using other payment methods 1404A including traditional fiat payments as well as digital currency payments with tokens or currencies. A part of the profit obtained from non-SWIX payments 1404A can be converted 1406 into SWIX token through the SWIX buyback 1406. The SWIX buyback thus can be a value onramp into the SWIX token economy.

Acquired SWIX tokens can be placed in a tokenback budget 1408 to ensure that user devices 202 associated with guests 1402 receive the tokenback rewards 1410. Excess SWIX tokens 1412 aggregated overtime can be redistributed to user devices 202 associated with active ecosystem participants.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method with the steps of: at a server comprising a processor, a memory, and a network interface device connected to a network, maintaining access to a plurality of property data contracts on a decentralized blockchain ledger, each property data contract associated with a real property in a locale and a cancellation policy data contract, receiving a booking data operation from a user electronic device comprising a cryptocurrency transaction and a cryptocurrency address, and verifying the booking data operation relative to the cancellation policy contract. Responsive to the verifying, approving the booking data operation based on at least one attribute of the user electronic device, processing the cryptocurrency transaction, updating the ledger, and after the booking data operation has been approved, running a token data operation to provide a token to the cryptocurrency address associated with the user electronic device.

According to some implementations, the server can maintain access to a plurality of master property data fields, including the property data contracts from the ledger together with property data fields from one or more external partner services. After receiving a second booking data operation from a second user electronic device comprising a fiat payment transaction, the server can verify the second booking data operation relative to the cancellation policy contract from the second booking data operation. And, responsive to the verifying the second booking data operation, the server can process the fiat payment transaction and update the ledger. According to some examples, after the second booking data operation has been approved, when the second user electronic device is not associated with any cryptocurrency address, the server can associate a second cryptocurrency address with the second user electronic device, run a token buyback data operation and distribute one or more tokens received by the token buyback data operation to the second cryptocurrency address.

Implementations may include one or more of the following features: the cryptocurrency transaction includes any one of: a fiat payment, an Ethereum payment, a MATIC payment or other distributed network native digital currency payment, an ERC20 payment, or comparable token standard, token payment and a SWIX token payment; providing a second token to a second cryptocurrency address associated with a token depositary; the token may entitle a user associated with the cryptocurrency address to participate in governance of the real property in the locale; the plurality of property data contracts comprises home stays and experiences in the locale; the booking data operation from a user electronic device is generated using a decentralized application; the token is an algorithmic digital currency; verifying at least one KYC data field of the user electronic device.

One general aspect includes at least one non-transitory computer-readable storage medium storing instructions that, when executed by at least one processor, cause the at least one processor to maintain access to a plurality of property data contracts on a decentralized blockchain ledger, each property data contract associated with a real property in a locale and a cancellation policy data contract, receive a booking data operation from a user electronic device comprising a cryptocurrency transaction and a cryptocurrency address, verify the booking data operation relative to the cancellation policy contract, responsive to the verifying, approve the booking data operation, process the cryptocurrency transaction and update the ledger. After the booking data operation has been approved, the processor runs a token data operation to provide a token to the cryptocurrency address associated with the user electronic device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refers to at least one of something selected from the group consisting of A, B, C . . . and N, the text should be interpreted as requiring only one element from the group, not A plus N, or B plus N, etc.

What is claimed is:

1. A method comprising the steps of:
at a server comprising a processor, a memory, and a network interface device connected to a network,
maintaining access to a plurality of property data contracts on a decentralized blockchain ledger, each property data contract associated with a real property in a locale and a cancellation policy data contract;
receiving a first booking data operation from a first user electronic device comprising a cryptocurrency transaction and a cryptocurrency address;
verifying the first booking data operation relative to the cancellation policy data contract;
responsive to the verifying, processing the cryptocurrency transaction and updating the decentralized blockchain ledger; and
after the first booking data operation has been approved, running a token data operation to provide a token to the cryptocurrency address associated with the first user electronic device.

2. The method of claim 1 wherein the method further comprises the server:
maintaining access to a plurality of master property data fields, comprising the property data contracts from the decentralized blockchain ledger together with property data fields from one or more external partner services;
receiving a second booking data operation from a second user electronic device comprising a fiat payment transaction;
verifying the second booking data operation relative to the cancellation policy data contract;
responsive to the verifying, processing the fiat payment transaction and updating the decentralized blockchain ledger;
after the second booking data operation has been approved, when the second user electronic device is not associated with any cryptocurrency address, associating a second cryptocurrency address with the second user electronic device; and
distributing one or more tokens to the second cryptocurrency address.

3. The method of claim 2 wherein the method further comprises the server:
after the first or second booking data operation has been approved, running a token buyback data operation; and
distributing one or more tokens received by the token buyback data operation to one or more cryptocurrency addresses associated with the locale.

4. The method of claim 1 wherein the cryptocurrency transaction comprises any one of a fiat payment, an Ethereum payment, a MATIC payment, an ERC20 token and a SWIX token payment.

5. The method of claim 1 wherein running the token data operation further comprises providing a second token to a second cryptocurrency address associated with a token depositary.

6. The method of claim 1 wherein the plurality of property data contracts comprises stays and experiences in the locale.

7. The method of claim 1 wherein the first booking data operation from a user electronic device is generated using a decentralized application.

8. The method of claim 1 wherein the token is an algorithmic digital currency.

9. The method of claim 1 further comprising verifying at least one KYC data field of the first user electronic device.

10. A server comprising a processor, a memory, and a network interface device connected to a network, wherein the server:
maintains access to a plurality of property data contracts on a decentralized blockchain ledger, each property data contract associated with a real property in a locale and a cancellation policy data contract;
receives a booking data operation from a user electronic device comprising a cryptocurrency transaction and a cryptocurrency address;
verifies the booking data operation relative to the cancellation policy data contract;
responsive to the verifying, approves the booking data operation, processes the cryptocurrency transaction and updates the decentralized blockchain ledger; and
after the booking data operation has been approved, runs a token data operation to provide a token to the cryptocurrency address associated with the user electronic device.

11. At least one non-transitory computer-readable storage medium storing instructions that, when executed by at least one processor, cause the at least one processor to:
maintain access to a plurality of property data contracts on a decentralized blockchain ledger, each property data contract associated with a real property in a locale and a cancellation policy data contract;
receive a booking data operation from a user electronic device comprising a cryptocurrency transaction and a cryptocurrency address;
verify the booking data operation relative to the cancellation policy data contract;
responsive to the verifying, approve the booking data operation, process the cryptocurrency transaction and update the decentralized blockchain ledger; and
after the booking data operation has been approved, run a token data operation to provide a token to the cryptocurrency address associated with the user electronic device.
